(19) United States
(12) Patent Application Publication
(10) Pub. No.: US 2009/0319940 A1
(43) Pub. Date: Dec. 24, 2009

(54) NETWORK OF TRUST AS MARRIED TO MULTI-SCALE

(75) Inventors: Gary W. Flake, Bellevue, WA (US); Blaise Aguera y Arcas, Seattle, WA (US); Anthony T. Chor, Bellevue, WA (US); Karim Farouki, Seattle, WA (US); Stephen L. Lawler, Redmond, WA (US); Ariel J. Lazier, Seattle, WA (US); Adam P. Sheppard, Seattle, WA (US); Richard Stephen Szeliski, Bellevue, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/142,906

(22) Filed: Jun. 20, 2008

(51) Int. Cl. G06F 3/048; G06F 17/30; G06F 7/06

(52) U.S. Cl. 715/781; 707/3; 715/850; 707/5; 707/E17.014

(57) ABSTRACT

The claimed subject matter provides a system and/or a method that facilitates visually representing data relationships within a network. A network includes a graphical representation of a user in which the network is a node structure with relationships between two or more users. An organization component that can analyze one of a degree of separation between two or more users represented within the network or an expertise level of a user represented within the network, the expertise level corresponds to a topic. The organization component can scale the portion of graphic representative based upon the analysis.

### CROSS REFERENCE TO RELATED APPLICATION(S)

This application relates to U.S. patent application Ser. No. ______ filed on ______, entitled “COLLECTION REPRESENTS COMBINED INTENT (MS322072.01/MSFTP2118US)” and U.S. patent application Ser. No. ______ filed on ______, entitled “CLIENT-SIDE COMPOSING/WEIGHTING OF ADS (MS322067.01/MSFTP2113US).” The entireties of such applications are incorporated herein by reference.

### BACKGROUND

The emergence of global communication networks such as the Internet and major cellular networks has precipitated interaction between users and other network entities. Not only are cellular and IP networks now a principal form of communications, but also a central means for interacting with other users for most purposes. Network users now have mechanisms for searching and communicating (or socializing) on virtually any topic of interest. However, this vast resource of information can also be an impediment to finding information as it continues to grow with no end in sight. This presents a formidable challenge when trying to find the information desired or other users who have similar points of interest.

One such network entity that provides social interaction around common subjects is the social network. Social network theory focuses on the relationships and links between individuals or groups of individuals within the network, rather than the attributes of individuals or entities. Smaller, stronger networks can be less useful to network individuals than networks with many weak links to individuals outside the main network. Generally, a social network can be described as a structure of nodes that represent individuals or groups of individuals (e.g., organizations). Social networking can also refer to a category of network applications that facilitate connecting friends, business partners, or other entities or groups of entities together.

Social networks with many weak links and social connections are more likely to provide new ideas and opportunities to the network individuals or groups than relatively closed networks that can have many redundant links such as in a group of individuals who routinely interact, and may already share the same knowledge and opportunities. Accordingly, individuals or groups of individuals of the social network having connections to other social entities are more likely to have access to a wider range of different information. Thus, social networks can function as a source of information that is more relevant to what a user may want.

Conventionally, published content, web pages, networks (e.g., IP networks, cellular networks, social networks, etc.), or other web-displayed content have attempted to develop efficient and aesthetically pleasing display techniques. Yet, conveying and organizing network information such as, connections, links, relationships, and the like can be confusing, convoluted, and over-crowded.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to a network in which various levels of trust or expertise can be reflected by multi-scales of size or other emphasis. Within a social network, for instance, an organization component can represent a close relationship with a large graphic (e.g., icon, picture, name, web page, profile, etc.) and decrease in size or scale as the degree of separation increases. Moreover, a scale or size can correspond to a level of expertise for a user within a particular topic or area. For example, a close friend can be represented by a large scale (e.g., demonstrating a close relationship), yet when wine knowledge is selected as a sorting criteria, the friend can be a smaller scale (noting the lack of knowledge in wines).

Additionally, the organization component can employ a hierarchy of multi-scale factors in order to optimize scaling or sizes. In other words, more or less weight can be given to a particular user or network based on the area or context. For example, based on context or domains, a social network can be more weighted than others. In another instance, an expert's opinion may be most heavily weighed. Still further, some circumstances can favor a combination of social networks and experts. Some examples include the following: a plumber service inquiry may place more weight on a social network due to locality of the service; an inquiry related to digital camera lenses may heavily weigh an expert since such topic requires deep informational knowledge; and an inquiry related to a restaurant can utilize a combination of an expert and the social network. In other aspects of the claimed subject matter, methods are provided that facilitate structuring data in an organized manner to reflect relationships and/or expertise in regards to a defined criteria (e.g., topic, trust, etc.).

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates generating a scaled view/graph representative of data and relationships associated with a network.

FIG. 2 illustrates a block diagram of an exemplary system that facilitates evaluating two or more view levels associated with a portion of image data in order to scale data according to relationships and/or expertise.

FIG. 3 illustrates a block diagram of an exemplary system that facilitates scaling data from a network based on a level of expertise for a topic identified within a browsing session.

FIG. 4 illustrates a block diagram of an exemplary system that facilitates aggregating a plurality of networks to render a scaled view of data and respective relationships.

FIG. 5 illustrates a block diagram of exemplary system that facilitates enhancing implementation of rendering scaled views of data with a display technique, a browse technique, and/or a virtual environment technique.

FIG. 6 illustrates a block diagram of an exemplary system that facilitates organizing data based upon strength of relationships and/or level expertise for a particular topic.

FIG. 7 illustrates an exemplary methodology for generating a scaled graph representative of data and respective relationships associated with a network.

FIG. 8 illustrates an exemplary methodology that facilitates evaluating network data in order to scale such data according to a level of expertise for a topic.

FIG. 9 illustrates an exemplary networking environment, wherein the novel aspects of the claimed subject matter can be employed.

FIG. 10 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “network,” “structure,” “engine,” “session,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

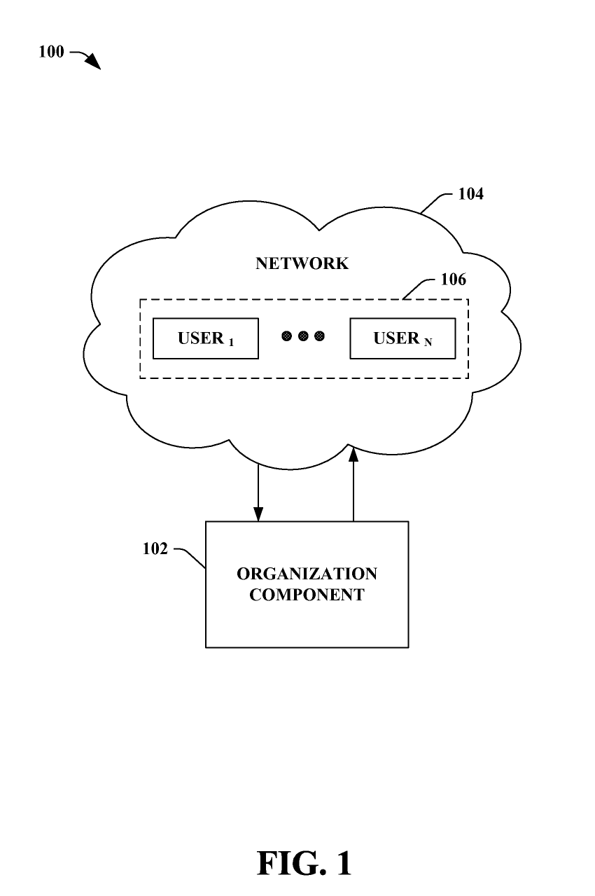

Now turning to the figures, FIG. 1 illustrates a system 100 that facilitates generating a scaled view/graph representative of data and respective relationships associated with a network. The system 100 can include an organization component 102 that can generate a scaled view of data associated with a network 104. The organization component 102 can evaluate the network to identify data and relationships between two or more users 106, wherein data can be scaled based upon, for instance, relationship strength, degree of separation, topic knowledge, or expertise. The network 104 can include any suitable number of users such as user₁ to user_{N}, where N is a positive integer. In particular, the network 104 can include two or more users 106 graphically represented as an icon, an avatar, a portion of text, a tag, a picture, and the like. Such graphical representation can be scaled by the organization component 102 based on criteria selected (e.g., relationship strength, topic knowledge, degree of separation, etc.). In general, the organization component 102 can promote or demote data within the network 104 as a function of a task, wherein such promotion or demotion is a change in scale, size, opacity, transparency, color, resolution, and/or any other suitable attribute related to the data.

For example, a social network can include graphical representations of users. Within the social network, each user can have relationships or connections to other users as well as information or personal data. The connections, relationships, and ties between users can be reflected by a scaling or size of the graphical representation. Moreover, a first graphic representative of a user can include a first friend, a second friend, and a third friend (e.g., each graphically represented within the social network). Based on the strength of the relationship, each graphical representation can be scaled or re-sized. Thus, a strong (close) relationship can be reflected by a large size or scale and a weak (distant) can be reflected by a small size or scale. In the example, the first friend can be a large size (demonstrating a close relationship), the second friend can have a smaller size (demonstrating a close relationship but not as close as the first friend), and the third friend can have a smallest size or scale (indicating a weak relationship).

In another example, the network can be a computer network within a work or business environment. In such example, the organization component 102 can scale or resize data (e.g., computer icons, entity icons/representations, etc.) based on relationship strength, knowledge, degree of separation, expertise, proximity, resources (e.g., software, hardware, processor, memory, etc.), duration of employment, personal data (e.g., age, hometown, address, nationality, height, weight, etc.), position, salary, etc. For example, the graphical representations of entities (e.g., users, machines, devices, etc.) can be scaled in accordance to knowledge or experience in dealing with widget A. In another example, a disparate scaling can be employed on the graphical representations if knowledge or experience for widget B is selected. In still another example, strength of trust can be utilized as scaling criteria, wherein the strength of trust can be automatically identified (e.g., based on interactions, communications, ratings, etc.), user-defined, and/or any suitable combination thereof.

In another example, the system 100 can be utilized with a device such as a mobile communication device, an electronic device, a portable device, a portable digital assistant (PDA), a laptop, a computer, a machine, a cellular device, a smartphone, a portable gaming device, a gaming console, a desktop computer, a hand-held, a browsing device, a media player, a portable media device, etc. For example, a network of smartphone users having global positioning service (GPS) can be scaled in accordance with geographic proximity (e.g., a larger graphic for a close user and a smaller graphic for a user further away).

The system 100 can further include a data store (not shown) that can include any suitable data related to the organization component 102, the network 104, the two or more users 106, etc. For example, the data store can include, but not limited to including, graphical representations, relationships, scaled data, topic knowledge, expertise definitions, scaling preferences, user settings, profiles, usernames, social network data (e.g., personal data, relationships, friends, etc.), communication logs (e.g., email data, call history, calendar data, task data, instant messenger data, etc.), etc. It is to be appreciated that the data store can be local, remote, associated in a cloud (e.g., a collection of resources that can be remotely accessed by a user, etc.), and/or any suitable combination thereof.

It is to be appreciated that the data store can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 106 of the subject systems and methods is intended to comprise, without being limited to, these and any other suitable types of memory. In addition, it is to be appreciated that the data store can be a server, a database, a hard drive, a pen drive, an external hard drive, a portable hard drive, and the like.

In addition, the system 100 can include any suitable and/or necessary interface component (not shown), which provides various adapters, connectors, channels, communication paths, etc. to integrate the organization component 102 into virtually any operating and/or database system(s) and/or with one another. In addition, the interface component can provide various adapters, connectors, channels, communication paths, etc., that provide for interaction with the organization component 102, the network 104, the two or more users 106 within the network, and any other device and/or component associated with the system 100.

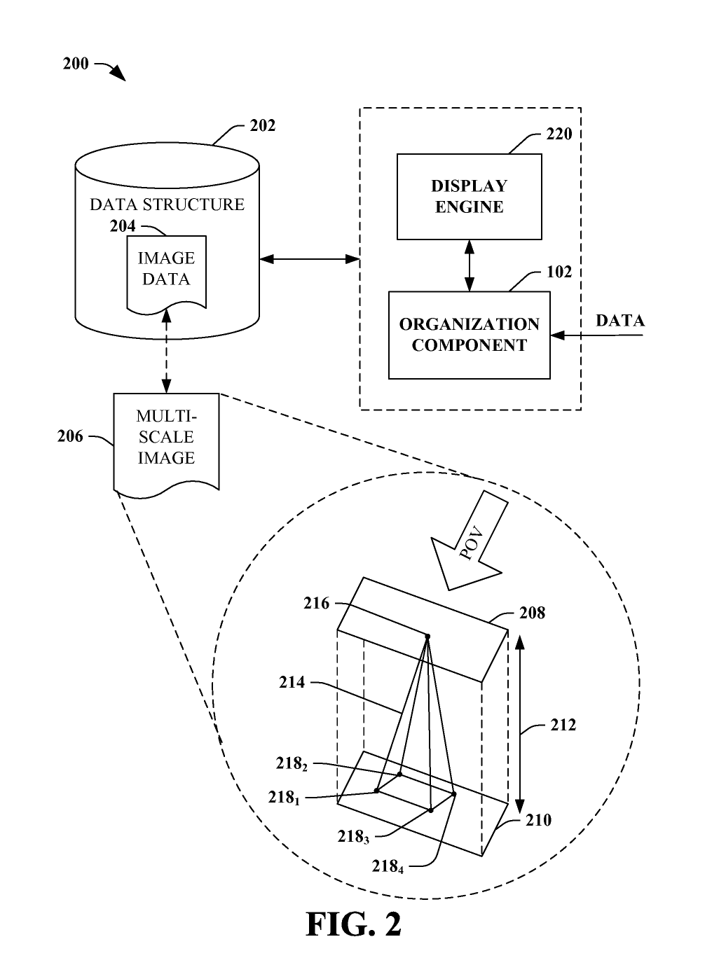

FIG. 2 illustrates a system 200 that facilitates evaluating two or more view levels associated with a portion of image data in order to scale data according to relationships and/or expertise. The system 200 can include the organization component 102 that can re-structure or organize data associated with a network based upon criteria such as user knowledge, user expertise, user trust, degree of separation, and/or user strength of relationship. In general, the organization component 102 can promote or demote (via scaling or re-sizing) based on relevancy for a task (e.g., data browsing, data query, etc.). The organization component 102 can receive data to define and establish a sorting criteria to allow data associated with a network (e.g., graphical representations of users, etc.) to be scaled, re-sized, and/or emphasized (e.g., color change, opacity, transparency, resolution, etc.).

It is to be appreciated that the organization component 102 can utilize various criteria to sort or scale data within the network. For example, the scaled view can be based upon at least one of a strength of relationship, an amount of trust associated with the user, an amount of knowledge for a topic, an amount of expertise, a duration of friendship, personal data, geographic location, communication availability, resources available (e.g., software, hardware, processor speed, memory, etc.), network speed, an amount of education, personal data (e.g., age, height, weight, marital status, etc.), machine data (e.g., functionality, model, age, cost, etc.), and/or any other suitable data included with a user or entity within a network.

Generally, system 200 can include a data structure 202 with image data 204 that can represent, define, and/or characterize computer displayable multiscale image 206, wherein a display engine 220 can access and/or interact with at least one of the data structure 202 or the image data 204 (e.g., the image data 204 can be any suitable portion of data within the network that is viewable, displayable, and/or browse able). In particular, image data 204 can include two or more substantially parallel planes of view (e.g., layers, scales, view-levels, etc.) that can be alternatively displayable, as encoded in image data 204 of data structure 202. For example, image 206 can include first plane 208 and second plane 210, as well as virtually any number of additional planes of view, any of which can be displayable and/or viewed based upon a level of zoom 212. For instance, planes 208, 210 can each include content, such as on the upper surfaces that can be viewable in an orthographic fashion. At a higher level of zoom 212, first plane 208 can be viewable, while at a lower level zoom 212 at least a portion of second plane 210 can replace on an output device what was previously viewable.

Moreover, planes 208, 210, et al., can be related by pyramidal volume 214 such that, e.g., any given pixel in first plane 208 can be related to four particular pixels in second plane 2 10. It should be appreciated that the indicated drawing is merely exemplary, as first plane 208 need not necessarily be the top-most plane (e.g., that which is viewable at the highest level of zoom 212), and, likewise, second plane 210 need not necessarily be the bottom-most plane (e.g., that which is viewable at the lowest level of zoom 212). Moreover, it is further not strictly necessary that first plane 208 and second plane 210 be direct neighbors, as other planes of view (e.g., at interim levels of zoom 212) can exist in between, yet even in such cases the relationship defined by pyramidal volume 214 can still exist. For example, each pixel in one plane of view can be related to four pixels in the subsequent next lower plane of view, and to 216 pixels (a vertex of pyramidal volume 214) in the next subsequent plane of view, and so on. Accordingly, the number of pixels included in pyramidal volume at a given level of zoom, l, can be described as p=4^{l}, where l is an integer index of the planes of view and where l is greater than or equal to zero. It should be appreciated that p can be, in some cases, greater than a number of pixels allocated to image 206 (or a layer thereof) by a display device (not shown) such as when the display device allocates a relatively small number of pixels to image 206 with other content subsuming the remainder or when the limits of physical pixels available for the display device or a viewable area is reached. In these or other cases, p can be truncated or pixels described by p can become viewable by way of panning image 206 at a current level of zoom 212.

However, in order to provide a concrete illustration, first plane 208 can be thought of as a top-most plane of view (e.g., l=0) and second plane 210 can be thought of as the next sequential level of zoom 212 (e.g., l=1), while appreciating that other planes of view can exist below second plane 210, all of which can be related by pyramidal volume 214. Thus, a given pixel in first plane 208, say, pixel 216, can by way of a pyramidal projection be related to pixels 218₁-218₄ in second plane 210. The relationship between pixels included in pyramidal volume 214 can be such that content associated with pixels 218₁-218₄ can be dependent upon content associated with pixel 216 and/or vice versa. It should be appreciated that each pixel in first plane 208 can be associated with four unique pixels in second plane 210 such that an independent and unique pyramidal volume can exist for each pixel in first plane 208. All or portions of planes 208, 210 can be displayed by, e.g. a physical display device with a static number of physical pixels, e.g., the number of pixels a physical display device provides for the region of the display that displays image 206 and/or planes 208, 210. Thus, physical pixels allocated to one or more planes of view may not change with changing levels of zoom 212; however, in a logical or structural sense (e.g., data included in image data 204) each success lower level of zoom 212 can include a plane of view with four times as many pixels as the previous plane of view.

Accordingly, a network (e.g., a social network, an IP network, a computer network, cellular network, etc.) as described can include multiple view-levels associated with the graphical representation of users. For instance, a user can include a profile page in which various view-levels can exist with particular data displayed respectively. In another instance, the user can include a listing of friends or relationships (e.g., the listing of friends can be pictures, text, etc.), wherein each friend can include a profile page with respective and various view-levels. It can be appreciated that the organization component 102 can evaluate data within the network (e.g., data structure 202, image data 204, multi-scale image 206, etc.) in order to scale or adjust the size of a graphic (corresponding to a user) based on a relevancy to the selected sorting criteria.

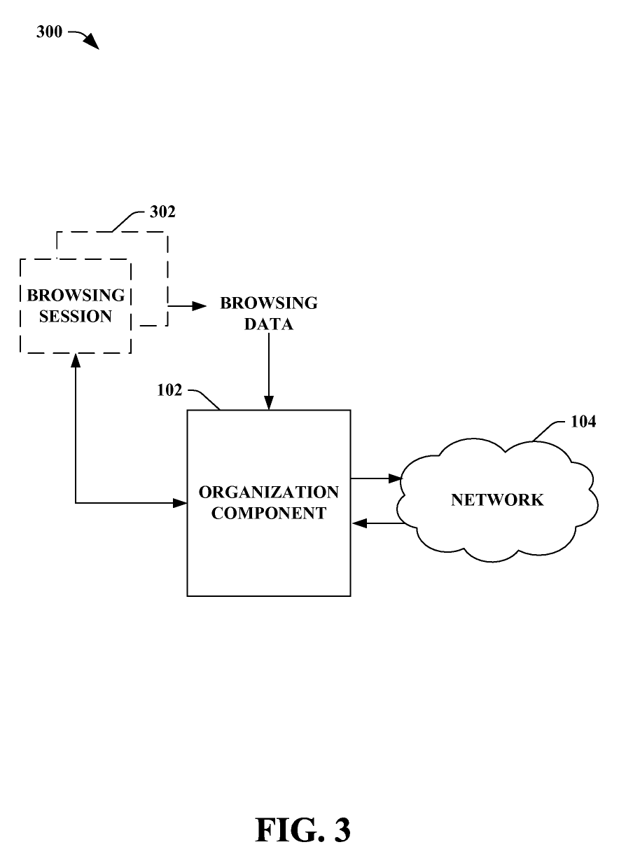

FIG. 3 illustrates a system 300 that facilitates scaling data from a network based on a level of expertise for a topic identified within a browsing session. The system 300 can include the organization component 102 that can scale data associated within the network 104 in accordance with sorting criteria. As discussed above, the sorting criteria can be relationship strength, an amount of trust, knowledge of a topic, expertise, degree of separation, geographic proximity, amount of common interests, and/or any other suitable criteria that can be filtered and sorted based on information within the network 104. It is to be appreciated that the organization component 102 can be a stand-alone component (as depicted), a portion of software, a portion of hardware, incorporated into the network 104, a client, a collaboration client, an instant messenger client, etc.

Furthermore, the scaled results for the sorting criteria can be user-defined, automatically inferred, and/or any suitable combination thereof For instance, if sorting criteria is a trust level (e.g., an amount of trust in general, relating to a particular topic, etc.), the trust level can be defined by the user or automatically inferred based upon communications, common data, ratings, duration of communications, evaluation of the network 104, etc. For example, the organization component 102 can evaluate communications between users within the network 104 in order to identify relationship strength (e.g., more communication can correspond to more strength or closeness). In still another example, the system 300 can utilize rankings or ratings from entities within the network 104 in order to identify accuracy or dependability for such entities. Thus, a user providing helpful information in regards to online auctions can receive a high ranking in that topic (which can be utilized for scaling purposes when sorting criteria is online auctions). Such rankings or ratings can be utilized to implement a hierarchy or weights (discussed below).

As mentioned, weights can be assigned to particular networks, factors, or other data (e.g., users, group of users, etc.) in order to accurately scale or re-size data within the network 104 (e.g., a hierarchy of multi-scale factors in order to optimize scaling or sizes). In other words, more or less weight can be given to a particular user or network based on the sorting criteria, area, or context. For example, based on context or domains, a social network can be more weighted than others. In another instance, an expert's opinion may be most heavily weighed. Still further, some circumstances can favor a combination of social networks and experts. Some examples include the following: a plumber service inquiry may place more weight on a social network due to locality of the service; an inquiry related to digital camera lenses may heavily weigh an expert since such topic requires deep informational knowledge; and an inquiry related to a restaurant can utilize a combination of an expert and the social network. Generally, the system 300 can utilize particular networks, experts, groups of experts, and/or any suitable combination thereof

For example, availability for users can be reflected by various scales in which the availability can be for chatting, phone calls, email, and the like. Thus, a user within the network (e.g., communication network, business environment network, social network, etc.) can be scaled larger if they are available and smaller if they are unavailable. In another example, the organization component 102 can scale users associated with an online gaming network in which the scale or size can correspond to connection speed, resources (e.g., computer components, software, hardware, peripherals, memory, processor, etc.), and proximity (e.g. ping distance, etc.). In still another example, the organization component 102 can implement scaling in connection with a cooperative task (e.g., online editing, authoring, shared collaborations, computer programmable code, etc.). Thus, users participating in an online collaboration of editing a document can be scaled or sized in accordance with selected sorting criteria (e.g., contribution, duration of editing time, amount of edits, etc.).

Furthermore, the organization component 102 can automatically scale or adjust data within the network 104 based upon content or context of a browsing session 302. The organization component 102 can analyze a portion of data within two or more browsing sessions 302 in order to identify a correlating content or context. It is to be appreciated and understood that the content or context of the browsing sessions 302 can be indicative of a topic of interest, wherein such topic of interest can be an automatically identified sorting criteria for scaling or re-sizing of data within the network 104. In other words, the system 300 can automatically and dynamically scale data within the network 104 (e.g., larger scale or size to reflect more relevance) based upon the context or inferred interest of the browsing session 302. Furthermore, the organization component 102 can leverage a group of users with common interests or browsed data, wherein such group of users can be scaled accordingly. In such an example, common interests can be sorting criteria and icons or avatars (representative of users) can be scaled based on the amount of similarities.

For example, a user can browse data utilizing any suitable browsing component or application in which multiple browsing sessions can be concurrently employed. Thus, a first window can browse a first data set, a second window can include a second data set that is explored, a third window can include a third data set that is displayed, and so on and so forth. The content and/or data related to each browsing session (e.g., first window, second window, third window, etc.) can be evaluated to identify a correlation or similarity to which a context can be ascertained. For instance, the browsing data (e.g., first data set, second data set, third data set, etc.) can be examined to determine a corresponding or common context. Based on such corresponding context, data within the network 104 can be scaled, re-sized, or emphasized accordingly in which such data is scaled based on relevancy to the context.

The organization component 102 can evaluate any suitable data associated with the one or more browsing sessions 302. For example, the organization component 102 can evaluate executing applications (e.g., word processing applications, communication applications, email applications, instant messenger applications, software, operating system data, etc.) associated with the browsing session 302. Furthermore, data related to the application can be evaluated in order to scale data based on an identified context from the browsing session 302. The data related to the application can be, but is not limited to, version data, type of application, frequency of use, copyright data, manufacturer, size of the application, etc. In another example, the organization component 102 can analyze behavior within the browsing session 302 such as, but not limited to, click frequency, scroll frequency, highlighting, inputs, input device location (e.g., mouse cursor, etc.), etc. In still another example, the organization component 102 can examine data from usage of the browsing session 302. For instance, the system 300 can evaluate information such as, but not limited to, duration of browsing on a particular portion of data, explicit tagging (e.g., adding to favorites, bookmarks, etc.), frequency of visit/browsing, data feed subscription (e.g., RSS feeds, etc.), subscriptions, newsletters, implicit user data (e.g., passive monitoring of browsing activity, etc.), explicit user data (e.g., search strings, contextual data, etc.), profile data, user settings, user preferences, user specific settings for a web page (e.g., personalized web sites, etc.), etc.

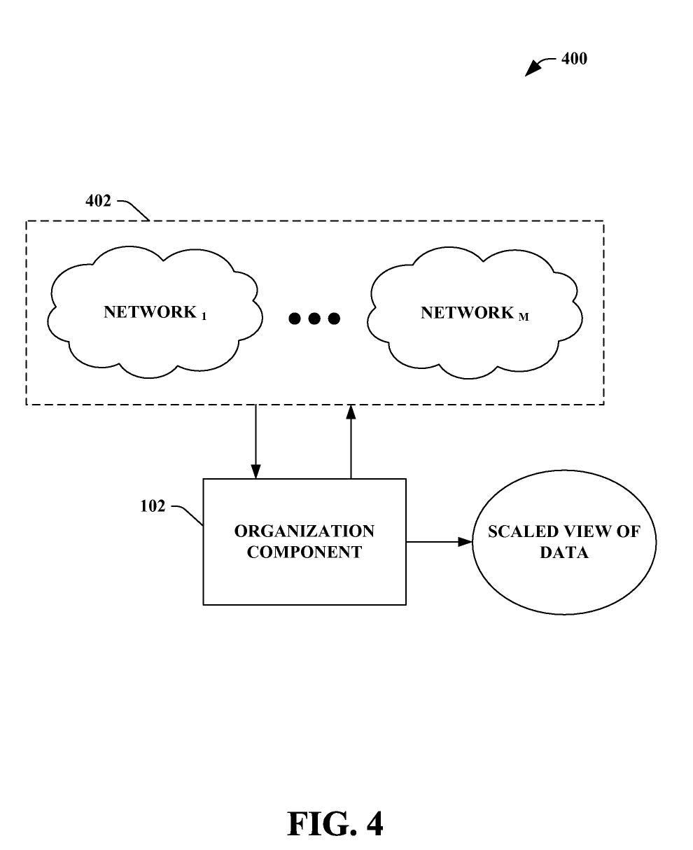

FIG. 4 illustrates a system 400 that facilitates aggregating a plurality of networks to render a scaled view of data and respective relationships. The system 400 can include the organization component 102 that can generate a scaled view of data according to sorting criteria. The organization component 102 can evaluate a plurality of networks 402 such as network₁ to network_{M}, where M is a positive integer. By leveraging the plurality of networks 402, the organization component 12 can aggregate such information to provide combined scaled views of data which include information from disparate networks. For instance, data within a social network and a business computing network can be scaled in accordance with sorting criteria (e.g., relationship, degree of separation, knowledge, expertise, etc.). By mining data from the plurality of networks 402, the scaled view of data can include numerous contacts, relationships, links, connections, and the like. In another example, a network can be weighted more or less based on an amount of confidence (e.g., confidence can be user driven, automatically inferred based on use, etc.). For example, a first social network can be more heavily weighted in comparison to a second social network based on user preference (e.g., an amount of use from a user, the number of contacts in the network, etc.). In this example, a user in the first network can be scaled a first size based on having a level of trust (e.g., the level of trust is the sorting criteria), whereas a user in the second network having the same level of trust can be scaled smaller than the first size since the first network is weighted more heavily.

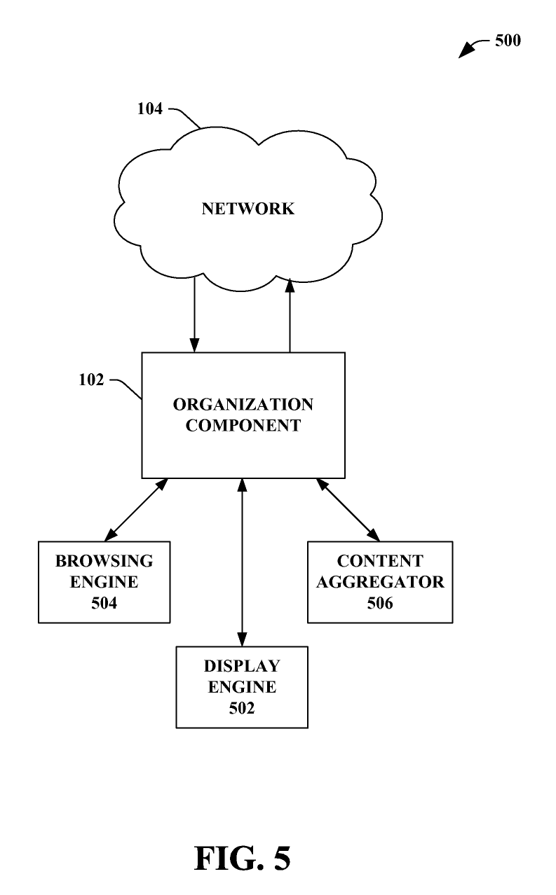

FIG. 5 illustrates a block diagram of exemplary system that facilitates enhancing implementation of rendering scaled views of data with a display technique, a browse technique, and/or a virtual environment technique. The system 500 can include the organization component 102 and the network 104 as described above. The system 500 can further include a display engine 502 that enables seamless pan and/or zoom interaction with any suitable displayed data or network data, wherein such data can include multiple scales or views and one or more resolutions associated therewith. In other words, the display engine 502 can manipulate an initial default view for displayed data by enabling zooming (e.g., zoom in, zoom out, etc.) and/or panning (e.g., pan up, pan down, pan right, pan left, etc.) in which such zoomed or panned views can include various resolution qualities. The display engine 502 enables visual information to be smoothly browsed regardless of the amount of data involved or bandwidth of a network. Moreover, the display engine 502 can be employed with any suitable display or screen (e.g., portable device, cellular device, monitor, plasma television, etc.). The display engine 502 can further provide at least one of the following benefits or enhancements: 1) speed of navigation can be independent of size or number of objects (e.g., data); 2) performance can depend on a ratio of bandwidth to pixels on a screen or display; 3) transitions between views can be smooth; and 4) scaling is near perfect and rapid for screens of any resolution.

For example, an image can be viewed at a default view with a specific resolution. Yet, the display engine 502 can allow the image to be zoomed and/or panned at multiple views or scales (in comparison to the default view) with various resolutions. Thus, a user can zoom in on a portion of the image to get a magnified view at an equal or higher resolution. By enabling the image to be zoomed and/or panned, the image can include virtually limitless space or volume that can be viewed or explored at various scales, levels, or views with each including one or more resolutions. In other words, an image can be viewed at a more granular level while maintaining resolution with smooth transitions independent of pan, zoom, etc. Moreover, a first view may not expose portions of information or data on the image until zoomed or panned upon with the display engine 502.

A browsing engine 504 can also be included with the system 500. The browsing engine 504 can leverage the display engine 502 to implement seamless and smooth panning and/or zooming for any suitable data browsed in connection with at least one of the Internet, a network, a server, a website, a web page, and the like. It is to be appreciated that the browsing engine 504 can be a stand-alone component, incorporated into a browser, utilized with in combination with a browser (e.g., legacy browser via patch or firmware update, software, hardware, etc.), and/or any suitable combination thereof For example, the browsing engine 504 can be incorporate Internet browsing capabilities such as seamless panning and/or zooming to an existing browser. For example, the browsing engine 504 can leverage the display engine 502 in order to provide enhanced browsing with seamless zoom and/or pan on a website, wherein various scales or views can be exposed by smooth zooming and/or panning.

The system 500 can further include a content aggregator 506 that can collect a plurality of two dimensional (2D) content (e.g., media data, images, video, photographs, metadata, trade cards, etc.) to create a three dimensional (3D) virtual environment that can be explored (e.g., displaying each image and perspective point). In order to provide a complete 3D environment to a user within the virtual environment, authentic views (e.g., pure views from images) are combined with synthetic views (e.g., interpolations between content such as a blend projected onto the 3D model). For instance, the content aggregator 506 can aggregate a large collection of photos of a place or an object, analyze such photos for similarities, and display such photos in a reconstructed 3D space, depicting how each photo relates to the next. It is to be appreciated that the collected content can be from various locations (e.g., the Internet, local data, remote data, server, network, wirelessly collected data, etc.). For instance, large collections of content (e.g., gigabytes, etc.) can be accessed quickly (e.g., seconds, etc.) in order to view a scene from virtually any angle or perspective. In another example, the content aggregator 506 can identify substantially similar content and zoom in to enlarge and focus on a small detail. The content aggregator 506 can provide at least one of the following: 1) walk or fly through a scene to see content from various angles; 2) seamlessly zoom in or out of content independent of resolution (e.g., megapixels, gigapixels, etc.); 3) locate where content was captured in relation to other content; 4) locate similar content to currently viewed content; and 5) communicate a collection or a particular view of content to an entity (e.g., user, machine, device, component, etc.).

It is to be appreciated that any suitable network data interacted with utilizing at least one of the display engine 502, the browsing engine 504, and/or the content aggregator 506 can be scaled or re-sized by the organization component 102. For example, the display engine 502 can navigate network data and included view levels as well as scaled views of network data (e.g., scaled based upon sorting criteria such as relationship, trust, degree of separation, amount of knowledge, expertise, etc.). In another example, the browsing engine 504 can be leveraged in which explored network data can be rendered with scales or sizes reflective of relevancy to sorting criteria. In still another example, network data exploration (e.g., viewed data, perspective of such viewed data, etc.) within a 3D environment created from 2D content can be scaled.

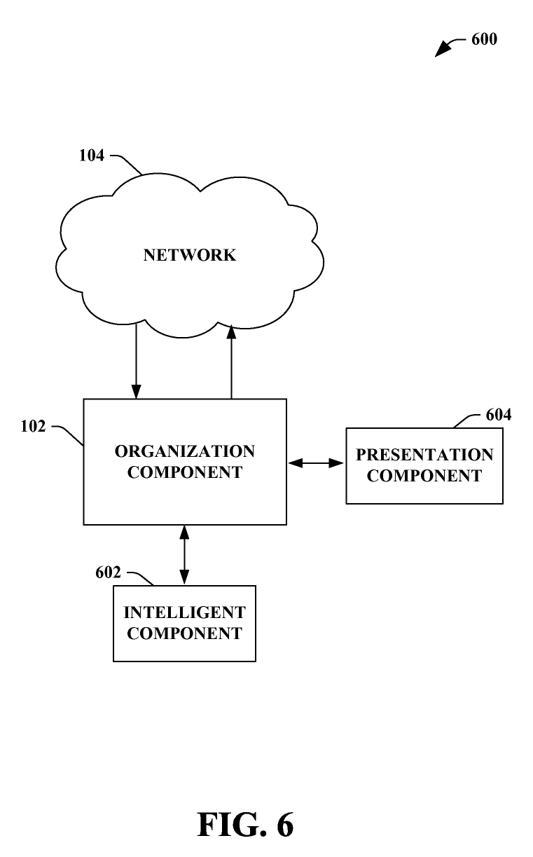

FIG. 6 illustrates a system 600 that employs intelligence to facilitate organizing data based upon strength of relationships and/or level expertise for a particular topic. The system 600 can include the organization component 102 and the network 104 which can be substantially similar to respective components and networks described in previous figures. The system 600 further includes an intelligent component 602. The intelligent component 602 can be utilized by the organization component 102 to facilitate scaling data in accordance with sorting criteria in order to efficiently display relationships and/or network data. For example, the intelligent component 602 can infer scaling, content related to a browsing session, context related to a browsing session, sorting criteria, amount of trust for a user, relationship strength, degree of separation, user knowledge of a topic, user expertise on a topic, a scaling or emphasis technique (e.g., color change, opacity, transparency, size, scale, resolution, etc.), relevancy to sorting criteria, weights for networks, weights for users, user preferences, user settings, communication habits for a user, level of trust for a user, etc.

The intelligent component 602 can employ value of information (VOI) computation in order to identify scaling network data according to sorting criteria. For instance, by utilizing VOI computation, the most ideal and/or appropriate scaling for a particular user can be determined. Moreover, it is to be understood that the intelligent component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

The organization component 102 can further utilize a presentation component 604 that provides various types of user interfaces to facilitate interaction between a user and any component coupled to the organization component 102. As depicted, the presentation component 604 is a separate entity that can be utilized with the organization component 102. However, it is to be appreciated that the presentation component 604 and/or similar view components can be incorporated into the organization component 102 and/or a stand-alone unit. The presentation component 604 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the organization component 102.

The user can also interact with the regions to select and provide information via various devices such as a mouse, a roller ball, a touchpad, a keypad, a keyboard, a touch screen, a pen and/or voice activation, a body motion detection, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, EGA, VGA, SVGA, etc.) with limited graphic support, and/or low bandwidth communication channels.

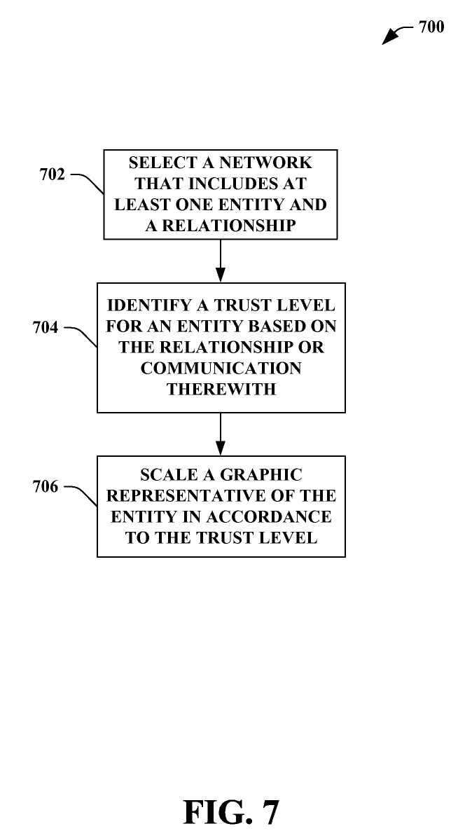

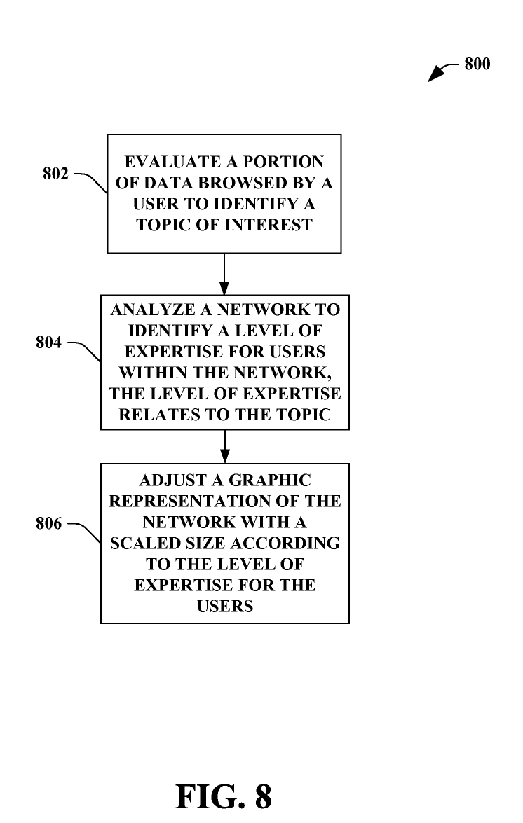

FIGS. 7-8 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts. For example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 illustrates a method 700 that facilitates generating a scaled graph representative of data and respective relationships associated with a network. At reference numeral 702, a network that includes at least one entity (e.g., user, machine, device, etc.) and a relationship can be selected. It is to be appreciated that the entity can be represented within the network as a portion of a graphic, a portion of text, a picture, a photo, an icon, an avatar, etc. The network can be, but is not limited to being, a social network, a computing network, a business network, an IP network, a cellular network, etc.

At reference numeral 704, a trust level for an entity based on the relationship or communication therewith can be identified. The trust level can be a measurement of how much trust a user has with the entity. In another example, the trust level can correspond with a degree of separation within the network. In other words, a trust level can be user-defined or automatically ascertained or inferred (e.g., evaluating communications, etc.). For instance, a user can set a high trust level for an entity within the network based on personal experiences. Moreover, the trust level can be automatically inferred based upon communications (e.g., email, messaging, calls, text messaging, voicemails, GPS location or proximity, etc.) or detected interaction with an entity within the network.

At reference numeral 706, a graphic representative of the entity can be scaled in accordance with the trust level. It is to be appreciated that the scale or re-size can be employed to further emphasize or demonstrate an amount of relevancy for the trust level. In one example, a high level of trust can be indicated by a larger scale or size, whereas a low level of trust can be indicated by a smaller scale or size.

FIG. 8 illustrates a method 800 for evaluating network data in order to scale such data according to a level of expertise for a topic. At reference numeral 802, a portion of data browsed by a user can be evaluated in order to identify a topic of interest. Any suitable data associated with the one or more browsing sessions can be evaluated in order to ascertain a user's interest, context, or topic of interest. Moreover, executing applications (e.g., word processing applications, communication applications, email applications, instant messenger applications, software, operating system data, etc.) associated with the browsing session can be evaluated. Furthermore, data or metadata related to the application can be evaluated in order to scale data based on an identified context from the browsing session.

At reference numeral 804, a network can be analyzed to identify a level of expertise for users within the network, the level of expertise can relate to the topic of interest. It is to be appreciated that the network and included data (e.g., users, interests, connections, profile data, etc.) can be leveraged or mined in order to ascertain knowledge or expertise. For example, a user's educational degrees can be evaluated from the network in order to identify a level of expertise for particular topics. In another example, a user's activity can be monitored and/or evaluated in order to identify topics to which one is educated/knowledgeable (e.g., web browsing, web sites, browsing history, news feeds, etc.). In still another example, a collection of users can be grouped as having knowledge on a topic to which the users have experience.

At reference numeral 806, a graphic representation of a user within the network can be adjusted with a scaled size according to the level of expertise of a user. In other words, a size or scaling of a user's graphic can correspond to an amount of knowledge or expertise for the topic identified within the data browsed. For example, a user browsing sports data can be presented with a scaled view of data in which a graphic for each user is scaled in accordance with their respective knowledge of the sports data. In another example, a user exploring vacationing in a location can be presented with a scaled view of data including users who have knowledge of such location.

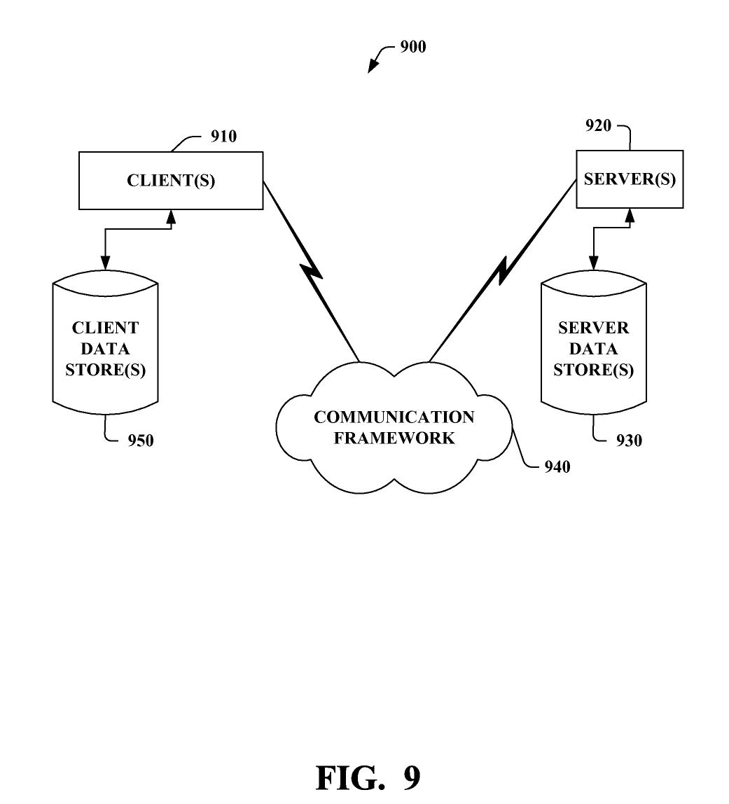

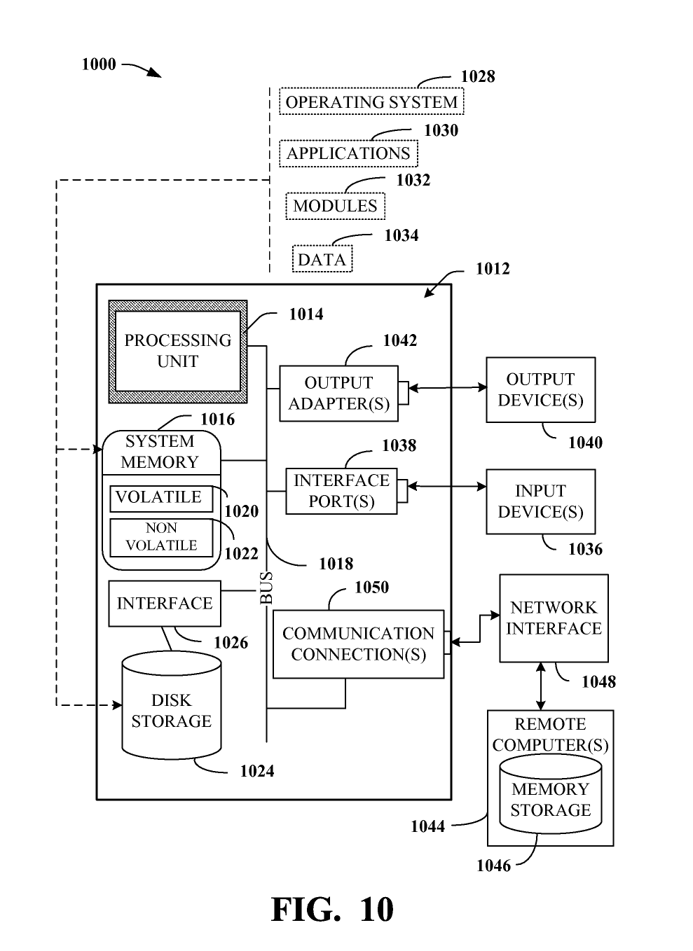

In order to provide additional context for implementing various aspects of the claimed subject matter, FIGS. 9-10 and the following discussion is intended to provide a brief, general description of a suitable computing environment in which the various aspects of the subject innovation may be implemented. For example, an organization component that can scale data from a network based upon relationship strength or knowledge of a topic, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 9 is a schematic block diagram of a sample-computing environment 900 with which the claimed subject matter can interact. The system 900 includes one or more client(s) 910. The client(s) 910 can be hardware and/or software (e.g., threads, processes, computing devices). The system 900 also includes one or more server(s) 920. The server(s) 920 can be hardware and/or software (e.g., threads, processes, computing devices). The servers 920 can house threads to perform transformations by employing the subject innovation, for example.

One possible communication between a client 910 and a server 920 can be in the form of a data packet adapted to be transmitted between two or more computer processes. The system 900 includes a communication framework 940 that can be employed to facilitate communications between the client(s) 910 and the server(s) 920. The client(s) 910 are operably connected to one or more client data store(s) 950 that can be employed to store information local to the client(s) 9 10. Similarly, the server(s) 920 are operably connected to one or more server data store(s) 930 that can be employed to store information local to the servers 920.

With reference to FIG. 10, an exemplary environment 1000 for implementing various aspects of the claimed subject matter includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in the suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the claimed subject matter can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system that facilitates visually representing data relationships within a network, comprising:
a network that includes at least one user represented by a portion of a graphic, the network is a node structure with a relationship between two or more users;
an organization component that analyzes at least one of the following:
a degree of separation between two or more users represented within the network; or
an expertise level of a user represented within the network, the expertise level corresponds to a topic; and
the organization component scales the portion of graphic representative of at least one user based upon the analysis.

2. The system of claim 1, the user within the network is represented by at least one of a portion of text, a picture, a photograph, an icon, an avatar, or an image.

3. The system of claim 1, the organization component scales the portion of graphic representative of at least one user based on sorting criteria, the sorting criteria is at least one of a relationship strength, knowledge of a topic, a geographic proximity, a computing resource, a duration of employment, a portion personal data, a position, a salary, an amount of education, an amount of trust, a duration of friendship, a communication availability, a network speed, a portion of machine data, an amount of common interests, a proximity between two machines, or a cooperative task attribute.

4. The system of claim 1, the network is at least one of a social network, a computing network, a business network, an Internet protocol (IP) network, or a cellular network.

5. The system of claim 1, further comprising a browsing session that includes a portion of data explored by a user, the portion of data explored is evaluated to identify a context which is indicative of an interest of the user.

6. The system of claim 5, the organization component identifies the interest with the browsing session by examining at least one of an application executing in connection with the browsing session, a user behavior within the browsing session, a portion of profile data, a browsing history related to a browsing session, usage of the browsing session, a portion of implicit user data, a portion of explicit user data, data related to a user preference, or content interaction history for a user.

7. The system of claim 5, the organization component identifies the interest with the browsing session by examining at least one of an application version data, type of application, frequency of use of the application, copyright data for the application, manufacturer of the application, size of the application, a click frequency within the browsing session, scroll frequency within the browsing session, a portion of highlighting within the browsing session, an input received during the browsing session, input device location, a duration of browsing on a particular portion of data, an explicit tagging within the browsing session, a frequency of browsing a portion of data, a data feed subscription, or data related to a user setting for a personalized web site.

8. The system of claim 5, the organization component scales at least one graphic representative of a user within the network, the scaling is reflective of at least one of an amount of knowledge for the interest, an amount of expertise for the interest, or an amount of similarity of the interest between the user and a disparate user within the network.

9. The system of claim 1, further comprising a display engine that browses the network, the display engine enables at least one of a seamless pan or a zoom interaction with the network, wherein such network includes one or more planes of view.

10. The system of claim 1, the network includes a portion of image data that represents a computer displayable multiscale image with at least two substantially parallel planes of view in which a first plane and a second plane are alternatively displayable based upon a level of zoom and which are related by a pyramidal volume, the multiscale image is scaled based upon the analysis.

11. The system of claim 10, the second plane of view displays a portion of the first plane of view at one of a different scale or a different resolution based upon the analysis.

12. The system of claim 10, the second plane of view displays a portion of the image data that is graphically or visually unrelated to the first plane of view based upon the analysis.

13. The system of claim 10, the second plane of view displays a portion of the image data that is disparate than the portion of the image data associated with the first plan of view based the analysis.

14. The system of claim 1, the network includes a 3-dimensional (3D) virtual environment created from a plurality of 2-dimensional (2D) content of an image that is navigated by the user, each portion of 2D content includes a perspective of the image, a portion of the image which is aggregated to create the 3D virtual environment of such image, and a portion of scaled data based upon the analysis.

15. The system of claim 1, the organization component employs a weighting factor to at least one of the network or a user within the network, the weighting factor is utilized for scaling the portion of graphic representative of at least one user.

16. The system of claim 1, the organization component monitors communications within the network to identify at least one of a weight factor for a user, a level of trust for a user, a strength of a relationship, an amount of knowledge for a topic, an amount of expertise for a topic, or an interest related to a user.

17. A computer-implemented method that facilitates organizing data and relationships within a network, comprising:
selecting a network that includes at least one entity and a relationship with a disparate entity, the entity is at least one of a machine, a user, or a computer;
identifying a trust level for the entity based upon at least one of the relationship, or a communication within the network;
representing the entity with a portion of a graphic; and
scaling the portion of a graphic in accordance to the identified trust level.

18. The method of claim 17, further comprising:
evaluating a portion of data browsed by a user;
identifying a topic of interest based upon the evaluation;
analyzing the network to identify a level of expertise for a user within the network, the level of expertise identified relates to the topic of interest; and
adjusting the graphic representation with a re-size, the re-size is indicative to the level of expertise for a user within the network.

19. The method of claim 17, further comprising scaling the portion of graphic representative of at least one user based on sorting criteria, the sorting criteria is at least one of a relationship strength, knowledge of a topic, a geographic proximity, a computing resource, a duration of employment, a portion personal data, a position, a salary, an amount of education, an amount of trust, a duration of friendship, a communication availability, a network speed, a portion of machine data, an amount of common interests, a proximity between two machines, or a cooperative task attribute.

20. A computer-implemented system that facilitates organizing data relationships within a social network, comprising:
means for representing a user with a portion of a graphic and a relationship between the user and a disparate user;
means for aggregating a plurality of represented users and relationships into a social network;
means for analyzing the social network to identify a strength of trust between two or more users, the strength of trust is ascertained by evaluating an amount of communication between the two or more users;
means for identifying a topic level of expertise for a user; and
means for scaling the portion of graphic representative of the user based upon one of the strength of trust or the topic level of expertise.
